(19) United States
(12) Patent Application Publication
(10) Pub. No.: US 2012/0185342 A1
(43) Pub. Date: Jul. 19, 2012

(54) SYSTEMS AND METHODS FOR UTILIZING CUSTOMER-PROVIDED INFORMATION WITHIN SOCIAL MEDIA APPLICATIONS

(76) Inventor: Michael Onghai, New York, NY (US)

(21) Appl. No.: 13/350,678

(22) Filed: Jan. 13, 2012

Related U.S. Application Data
(60) Provisional application No. 61/432,532, filed on Jan. 13, 2011.

(51) Int. Cl. G06Q 30/02

(52) U.S. Cl. 705/14.73

(57) ABSTRACT

A method for developing and hosting application software for advertisers includes providing a plurality of templates of social media apps for selection by an advertiser, receiving one or more selections by the advertiser from the plurality of templates, and creating an app for use within a social network based on the received selections. The created app can be hosted on a server and the created app can be provided with a uniform resource locator (URL). The advertiser can be provided with the URL of the created app so that the advertiser can share the URL with a plurality of users.

### CROSS-REFERENCE TO RELATED APPLICATION

This application claims the benefit of U.S. Provisional Application No. 61/432,532, which was filed on Jan. 13, 2011, and is incorporated herein by reference in its entirety.

### FIELD

The present disclosure is directed to methods and systems for utilizing customer-provided information within social media applications.

### BACKGROUND

Conventional online ad networks often operate by requesting or directing a customer to click on an ad (e.g., a banner ad) to be directed from the current location to another location away from the current location. Such advertisements are generally referred to as clickthrough advertisements because the advertiser is trying to get the customer to leave the current location by clicking on the ad. However, in some cases the user may already have provided the current location with valuable and/or useful information that may be advantageous to the advertiser. Since conventional online ad networks send the customer to another location, such conventional ad networks cannot take advantages of this already-provided information.

In some cases, advertisements can be provided within social networks. However, in order to take advantage of the information available provided to the social network (e.g., Facebook™), the advertiser must create and maintain the application within the social network. Because not all advertisers have the capabilities (e.g., either technical and/or financial) to create and maintain such applications on a social network, such advertiser are not able to take advantage of the information already provided to the social network by potential customers.

### SUMMARY

A method for developing and hosting application software for advertisers is provided. The method comprises providing a plurality of templates of social media apps for selection by an advertiser, receiving one or more selections by the advertiser from the plurality of templates, and creating an app for use within a social network based on the received selections. The created app can be hosted on a server and the created app can be provided with a uniform resource locator (URL). The advertiser can be provided with the URL of the created app so that the advertiser can share the URL with a plurality of users. In some embodiments, the created app is a Facebook™ app and the Facebook™ app is able to collect social or demographic data about the users from Facebook™.

In other embodiments, a method for developing and hosting application software for advertisers is provided. The method comprises creating apps for use within a social network for a plurality of advertisers based on preferences selected by the advertisers, hosting and maintaining the created apps on a server and providing each of the created apps with a unique uniform resource locator (URL), and publishing the created apps by presenting advertisements with one of the URLs linked to the advertisements. The advertisements are presented within the social network and the created apps are operable within the social network. In some embodiments, the created app is a Facebook™ app and the Facebook™ app is able to collect social or demographic data about the users from Facebook™.

In some embodiments, the system includes a computer-readable storage medium storing computer-executable instructions for causing a computer to perform the methods described herein.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a flow chart illustrating an exemplary advertiser app to app publisher exchange platform from the advertiser's perspective.

FIG. 2 illustrates a flow chart illustrating an exemplary advertiser app to app publisher exchange platform from the publisher's perspective.

FIG. 3 illustrates a flow chart illustrating an exemplary advertiser app to app publisher exchange platform from the ad delivery perspective.

FIG. 4 is a schematic block diagram of an exemplary computing system on which certain embodiments of the systems and methods disclosed herein can be implemented.

FIG. 5 is a block diagram illustrating a computer network that can be used to perform at least some of the embodiments of the systems and methods disclosed herein.

FIG. 6 is a block diagram illustrating another computer network that can be used to perform at least some of the embodiments of the systems and methods disclosed herein.

FIG. 7 is a block diagram illustrating how the computer networks of FIG. 5 or 6 can be used to perform certain aspects of the systems and methods disclosed herein.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

Social Networks and Other Such Media

Social media and mobile media apps are great platforms to conduct surveys, quizzes, polls for marketers and advertisers (“marketers”). However, there is not a convenient exchange platform that has kept up with the developments in social media and mobile apps that allows marketers and apps publishers to easily and conveniently take advantage of the information available within such social networks and other social media.

As discussed above, conventional ad networks for social networks and other media, such as application software (referred to herein as “apps”) that can operate within Facebook™ require an advertiser to provide a click-through URL and a banner. Thus, the advertiser is simply advertising a URL outside of the social network. In such cases, all the pre-existing information collected by Facebook™ and/or entered by the customer (e.g., potential customer information including social and demographic information) is lost because once a user is taken out of Facebook™, the pre-existing information associated with the potential customer (e.g., user) cannot be used or passed on to the advertiser.

As also discussed above, there are some apps that can operate within Facebook™ (or other social networks or media); however, in order to utilize these apps, the advertiser must have the capability of creating such an app. This requirement excludes many potential advertisers who do not have the capability to create an app or who cannot justify the cost of creating and maintaining an app on Facebook™.

Moreover, existing banners and other such advertisements are very real-estate intensive, making them unappealing to potential customers and advertisers alike. Finally, as more people spend time on various social networks like Facebook™, it will be more and more difficult for advertisers to create apps directed to specific social networks.

The above problems and deficiencies of current ad networks can be remedied by the systems and methods described herein. As described in more detail below, the systems and methods herein allow an advertiser to create an app (e.g., a quiz, poll, gifting app, game, etc.). Moreover, once created, the systems and methods disclosed herein can provide for the hosting and maintenance of that app for the advertiser.

Advertiser App to App Publisher Exchange Platform

The systems and methods described herein permit an advertiser to utilize information present within the social network. Thus, for example, the advertiser does not have to take the user out of Facebook™. Instead, the advertiser can have an app that exists inside Facebook™ and the potential customer (also referred to as a “user” herein) is directed from the publisher's app to the advertiser's app within Facebook™ so that the advertiser can still access the social and demographic information available within Facebook™.

In operation, advertisers can access the system, which can be provided in any accessible manner, such as via a web site. Advertisers can then select templates and automatically create apps that can be hosted and maintained within the system. The advertiser can then be provided an app URL that will be the click-through URL when their advertisement (text or banner) is clicked. The advertiser can then perform valuable analysis on usage of their app to track the effectiveness of their ad campaigns.

The system can provide text-based ad links in addition to banner ad links, thereby increasing the monetization potential of an app publisher client. In other embodiments, the advertiser can advertise his app within a virtual currency section of the app publisher.

Such app URLs that are provided to the advertiser can be used within Facebook™ and can include survey apps; however, in other embodiments, the system can provide apps and other software that can be utilized in other social networks or media.

In operation, instead of clicking through a banner to a web site outside of Facebook™ (or another social network), the user (i.e., potential customer) clicks on the link provided to the advertiser and is directed to the app provided to the advertiser by the system. Since the user is now viewing the advertiser's app, the app is able to access the user data provided by Facebook™. Currently, Facebook™ does not allow apps to store the user data or pass the user data outside of their social network. However, apps are allowed to access the data while the user is using the app. Thus, the advertiser is able to take advantage of this information by utilizing the app created by the system.

App to App Publisher Exchange Platform Additional Details

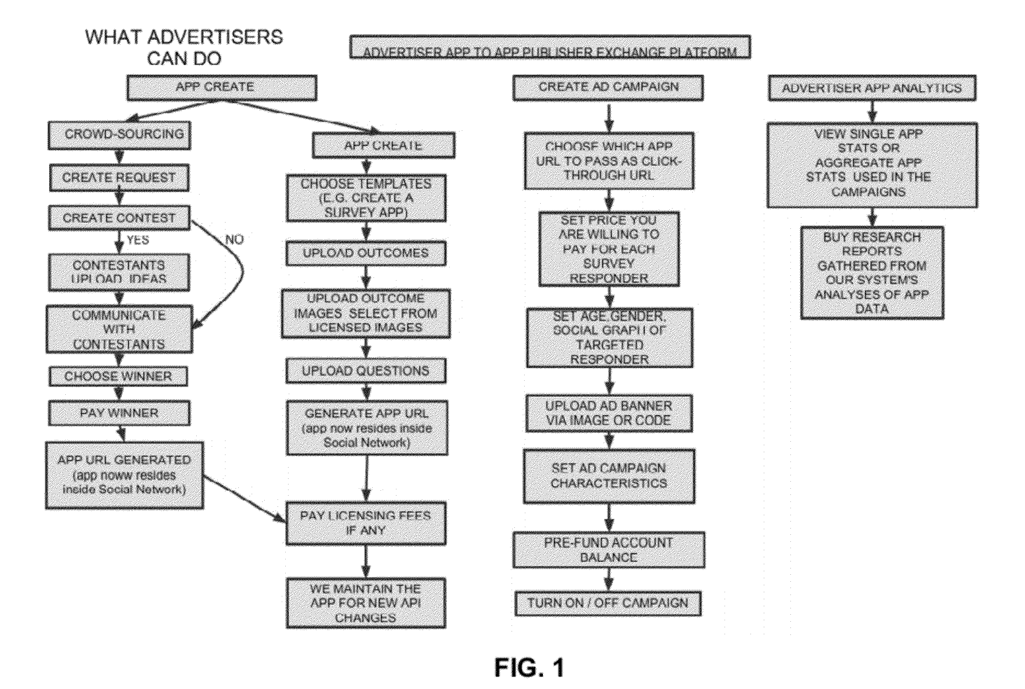

The Advertiser App to App Publisher Exchange Platform described herein comprises the following steps for developing an advertising campaign: (1) App Create, (2) App Publish, (3) Ad Serve, and (4) App Analytics. There are many novel functions all throughout the App Create, App Publish, Ad Serve, and the App Analytics components of our process. FIG. 1 illustrates various advantages and benefits of the systems.

In the App Creation Process, the advertiser is permitted to select a crowd-sourcing option to have their app content created by our network of freelancers or choose the “use our tool option.”

If advertiser selects “choose our tool,” the app is created by the person choosing templates and selecting various app related functions. Each app function works in conjunction with the other available functions. Some functions have a premium fee. In some embodiments, some functions can be provided so that they will work for a limited time for free. In other embodiments, the advertiser can select images, videos and/or music files for use with the app. Some of those elements can be used free; others however may require licensing from studios. If they have to be licensed from studios, then they will automatically be added to the shopping cart and the licensing studio records a sale.

Some of the code in our templates is free and some have to be licensed from the code owner. For example, the system can utilize an algorithm for creating online polls on social networks such as that shown in described in U.S. Patent Application Publication No. 2009/0181355, filed on Jan. 14, 2008, the entirety of which is incorporated herein by reference, and we can make this code available as one of our templates. Again, we automatically add to the cart and credit the code owner for license sales.

Facebook™ requires advertisers to provide app contact info, so that the advertiser can respond to user questions and/or user complaints. The system can allow us to be the point of contact person instead of the advertiser. This will also allow us to receive notifications from Facebook™ regarding application programming interface (API) changes. Thus, for example, the system can adapt its uses of apps accordingly, as well as advise and inform advertisers of any such changes.

Sourcing and Crowd-Sourcing of App Development

If an advertiser selects the “crowd-sourcing” option, then he goes to a page where he describes the app that he wants to create, how much he is willing to pay and what his deadline is, and whether he wants to launch a contest to select the winning provider or he wants to select the provider beforehand. His request can then be seen by many other freelancers who sign up to our platform. The freelancers and the advertiser can communicate freely.

If advertiser selects the contest option, then advertiser works with many freelancers and chooses the winner at the end of the contest period. If the advertiser selects the non-contest option, then advertiser works with one freelancer throughout the process. The freelancers themselves can use our automated app templates, upload their content and create the app. Payments can be handled through an escrow system. Buyer and seller feedback can be provided at the end of each job request.

The following example illustrates a person who chooses the non-crowdsourcing option:

Advertiser A wants to collect 2000 responses to a 4 question survey “What are your Favorite Foods?” Advertiser A goes to our platform and clicks on the “Create Advertiser App”. He then chooses the app type from a list (quiz app, survey app, poll app, gifting app, game app, etc.). He is then presented with screen(s) where he has to enter the text for the possible outcomes and can optionally submit (upload or provide the URL) the images (or video or audio) associated with each outcome. He then enters the text for the questions and can optionally submit (upload or provide the URL) the images (or videos or audio files) associated with the questions.

After reviewing that it is okay, he can then click ‘Publish the app’. The system can save all the entered data and wrap their uploaded content with a code and provide them with an App URL that will then become the click-through URL for their ad campaign.

App Publishing Process Additional Details

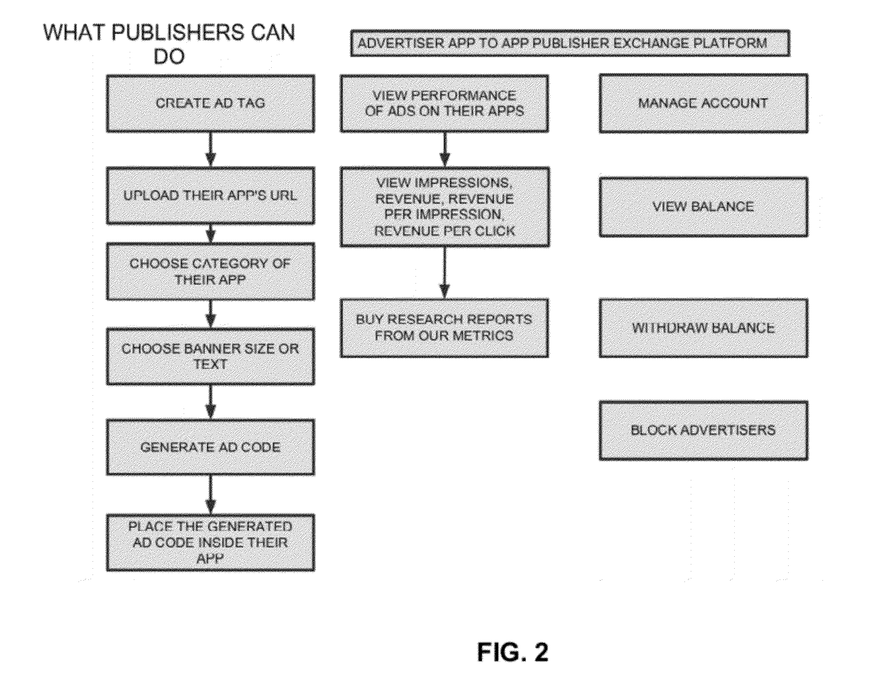

FIG. 2 illustrates a flow chart illustrating various benefits and advantages of an exemplary advertiser app to app publisher exchange platform in connection with the app publishing process. The person can set the price they are willing to pay per person who installs their app. The system can pay the publisher a percentage of this amount and keep the difference. The system will have the function to make sure that duplicate installers of the advertiser's app (coming through clicking on banners or links on 2 different publishers) are not counted twice so the advertiser is not charged twice. Our system has a real-time dynamic price algorithm that determines which advertiser's app to display at any time on a publisher's app that will optimize the publisher's revenues. Our system also keeps track of which ads have been displayed for which user.

Ad Serving Process Additional Details

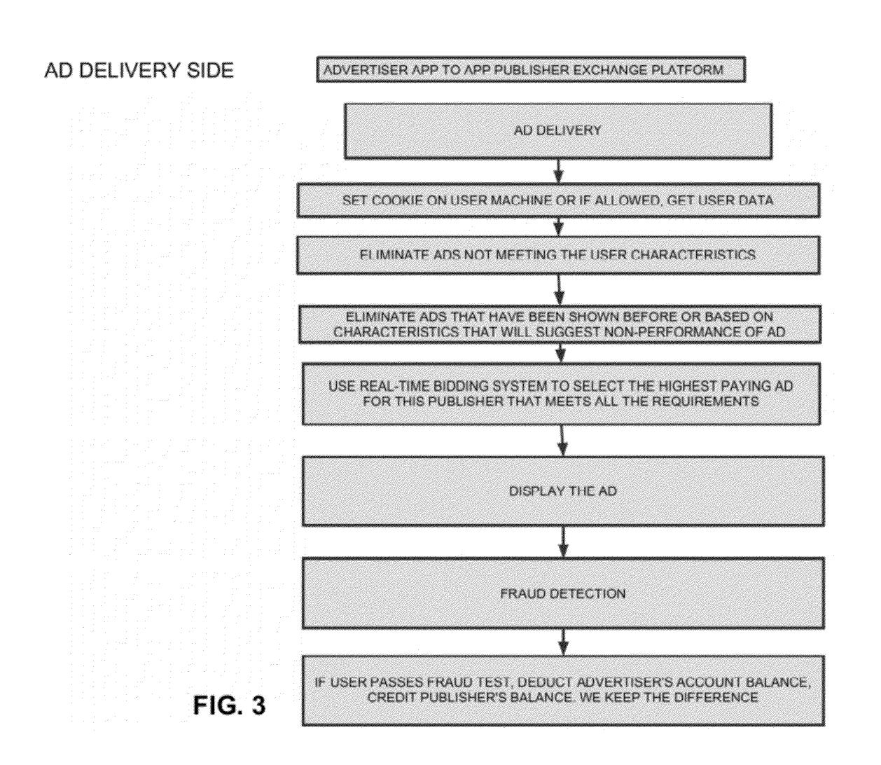

There are a lot of novel functions in the way we choose which ad to display to our publishers. FIG. 3 illustrates another flow chart illustrating various benefits and advantages of an exemplary advertiser app to app publisher exchange platform in connection with the ad service process. Ad delivery can be optimized to maximize two factors: higher revenues to the publishers, lower cost of customer acquisition for the advertiser. Since our platform hosts the apps of our advertisers, we have an added transparency to see the data, monitor the activity of the users who clicked on the ad banners served on our platform. We can use this data to help us determine the next ad banner to display to a particular user. For example, suppose we have three advertisers: Adv 1, Adv 2, Adv 3. Each of them has an app hosted in our platform. If user 1 has already installed Adv 1's app, we can make sure we do not display Adv 1 again to user in the future. Another example: if Adv 1's quiz app is a lot more viral than Adv 2's quiz app because the questions of Adv 1's quiz app is funnier, we can incorporate that insight when designing Adv 2's future survey campaigns.

App Analytics Process Additional Details

The advertiser can view statistics about the users who have used the apps. The system can show charts of various statistics about their users, including for example, normal curves of responses to their surveys. Advertisers can also be provided with statistics on an aggregate level across their apps.

The system can provide a function that allows people to create apps for free, but that if they create the apps, all data from the app users belong to us to use as we wish. Then we can provide people data on what apps might do well if they pay to create their own versions. We can catch early hot apps and then sell access to those app creation tools based on success statistics, so that app creation tool usage costs would go up and down like a market.

Accordingly, using the systems and methods described above, an advertiser (marketer) can use existing templates to create apps—quizzes, polls, gifting apps, games, and many more. The created app can then be hosted and maintained by the system for the advertiser.

The advertiser can also do one or more of the following using the systems and methods described herein:
a. Set the dollar amount they are willing to pay for each responder
b. Set the requirements (age, gender, locale, etc.) of the responder they seek.
c. Set the dollar amount they are willing to pay for each responder.
d. Publish their “surveys” and make it available to our network of app developers to list their survey to their audience.
e. Make sure they do not pay for duplicate responders
f. Real-time bidding so they can pay the lowest cost
g. View analytics, statistics of their responders and store all the answers.
h. Archival of their “surveys”.
i. Reporting of who took the “surveys”.

In addition, using the systems and methods described herein, an app developer/publisher can do one or more of the following:
a. Place within their apps links to the “surveys” and get paid for people who take the surveys.
b. Get reporting and view stats about their revenues and the performance of their ads
c. Take advantage of the real-time bidding system so they get paid the highest rate for their surveys.
d. Receive payments regularly via PayPal™, Visa™, Mastercard™.
e. Reporting of who took the “surveys”.

The ad server on our platform can optimize the ads that are displayed by the apps. Moreover, by introducing crowd-sourcing into the platform, creative freelancers can participate as a contest to create “surveys” (logos/videos/slogans) for customers, thereby winning work, getting reporting information and stats information about their creations, and receiving payments.

The above-description is mainly focused on apps that can operate on a social network such as Facebook™. However, it should be understood that other networks and media can be used to achieve the same effects described above. Thus, for example, such apps can be used on other social networks, such as Linkedln™, Twitter™, MySpace™, etc. In addition, it should be understood that access and use of the systems and methods described herein can be achieved using any computing device, including for example, portable devices such as laptops, iPhones, Android™ phones, etc. In addition, other media instead of apps can be hosted by the platforms described herein. For example, video ads can be hosted by such platforms as well.

Video Ad Exchange Platform

Another embodiment will be a video ad exchange platform. For example, an advertiser may want to show a video ad before or after a YouTube™ video. Again, if the advertiser does not have the resources to create a video, he can use a “Video Ad Creator” in our exchange platform. He can use our tools to create video to upload a video, choose from a collection of licensable videos, or splice together a series of video clips. Our system can automatically charge the advertiser license for the video. A video is created and that video can be inserted inside the YouTube™ video. Likewise, the advertiser can choose a “crowd-sourcing” option as in the earlier example we listed for Facebook™, and as described in detail above. As in the earlier embodiments, the system can host the video, keep track of user statistics, etc. The advertiser can set the amount he is willing to pay for each “view” of his video ad, or “per minute” viewed of his video ad. The system can also use real-time pricing dynamics and revenue optimization algorithms to display the video ad to the user.

Mobile-App Advertisement Platform

In another embodiment, an in-mobile-app advertisement platform is provided. The in-mobile-app platform can function similarly to the other platforms described herein. For example, an advertiser may want to advertise within a mobile app of an Android phone, but the advertiser does not have resources to create an Android™ app. He can use our ‘Mobile App Creator” to create an Android™ app. As described in other embodiments, he can use crowd-sourcing option or use our template tools. The mobile app is created and hosted within our platform and the advertiser is provided a click-through URL that he can use for his in-mobile-app advertisement campaigns. When a user inside a mobile app clicks his ad, the user is taken to the advertiser's mobile app, sparing the user from being taken outside to a web browser or a phone browser.

### Implementation of the Systems and Methods Disclosed Herein

Various systems and methods for utilizing customer-provided information within social media applications in the manners described above can be provided. In some embodiments, these systems may be implemented or performed, at least in part, by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

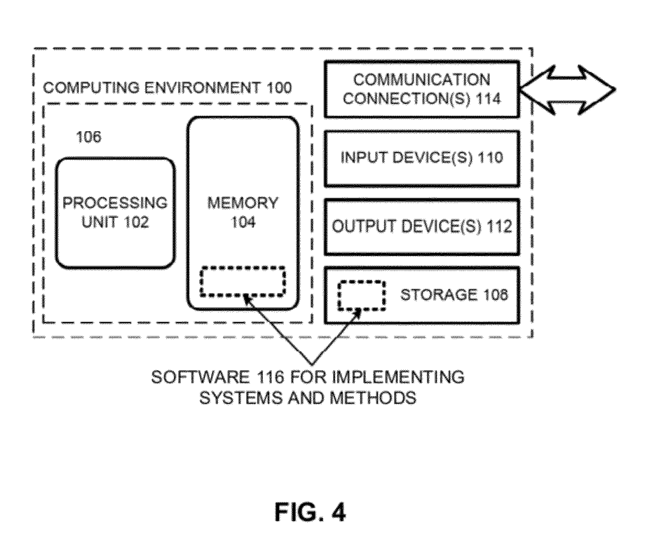

FIG. 4 illustrates a generalized example of a suitable computing environment 100 in which the described embodiments of systems and methods can be implemented. The computing environment 100 is not intended to suggest any limitation as to scope of use or functionality, as the methods described herein can be implemented in diverse general-purpose or special-purpose computing environments.

With reference to FIG. 4, the computing environment 100 includes at least one processing unit 102 and memory 104. In FIG. 4, this most basic configuration 106 is included within a dashed line. The processing unit 102 executes computer-executable instructions and may be a real or a virtual processor. In a multi-processing system, multiple processing units execute computer-executable instructions to increase processing power. The memory 104 may be volatile memory (e.g., registers, cache, RAM), non-volatile memory (e.g., ROM, EEPROM, flash memory, etc.), or some combination of the two. The memory 104 stores software 116 implementing one or more of the systems described herein.

The computing environment may have additional features. For example, the computing environment 100 includes storage 108, one or more input devices 110, one or more output devices 112, and one or more communication connections 114. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 108 may be removable or non-removable, and includes magnetic disks, magnetic tapes or cassettes, CD-ROMs, DVDs, or any other medium which can be used to store information and which can be accessed within the computing environment 100. The storage 108 can store instructions for the software 116 implementing any of the described systems and methods.

The input device(s) 110 can be a touch input device such as a keyboard, mouse, pen, or trackball, a voice input device, a scanning device, or another device that provides input to the computing environment 100. For audio or video encoding, the input device(s) 110 can be a sound card, video card, TV tuner card, or similar device that accepts audio or video input in analog or digital form, or a CD-ROM or CD-RW that reads audio or video samples into the computing environment 100. The output device(s) 112 can be a display or another device that provides output from the computing environment 100 to view the selected media content.

The communication connection(s) 114 enable communication over a communication medium to another computing entity. The communication medium is not a storage medium but conveys information such as computer-executable instructions, resource and construction project information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The various methods disclosed herein can be described in the general context of computer-readable media. Computer-readable media are any available media that can be accessed within or by a computing environment. By way of example, and not limitation, with the computing environment 100, computer-readable media include tangible computer-readable storage media such as memory 104 and storage 108.

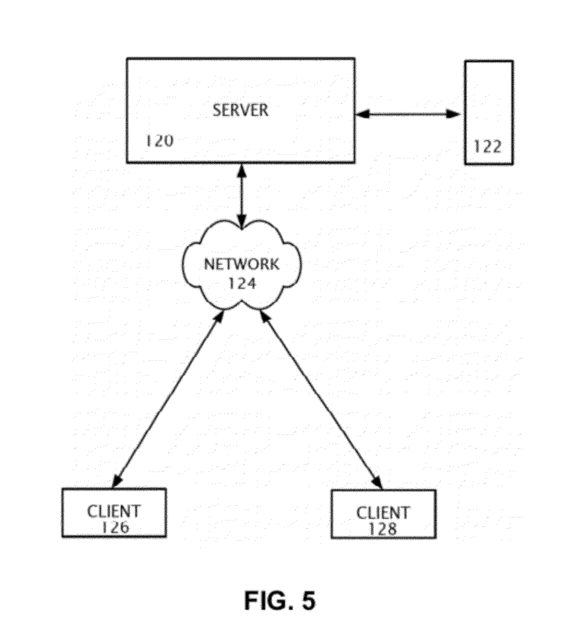

Any of the aspects of the technology described herein can also be performed using a distributed computer network. FIG. 5 shows a simplified embodiment of one such exemplary network. A server computer 120 can have an associated storage device 122 (internal or external to the server computer). For example, the server computer 120 can be configured to perform the calculations and analysis of information according to any of the disclosed embodiments. The server computer 120 can be coupled to a network, shown generally at 124, which can comprise, for example, a wide-area network, a local-area network, a client-server network, the Internet, or other such network. One or more client computers, such as those shown at 126, 128, may be coupled to the network 124 using a network protocol. The work may also be performed on a single, dedicated workstation, which has its own memory and one or more CPUs.

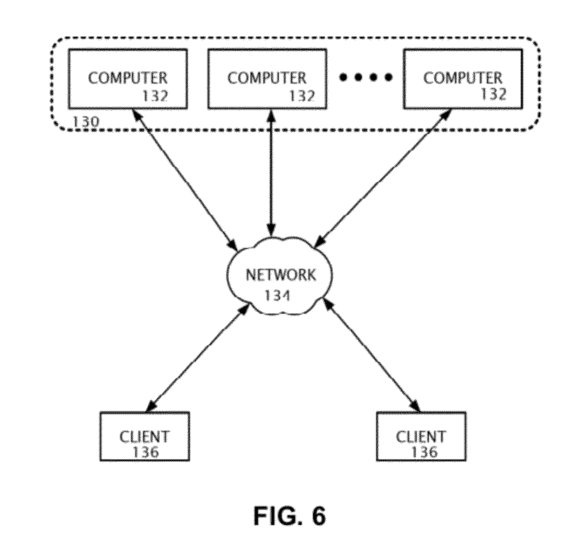

FIG. 6 shows another exemplary network, such as a network which can send and receive information and media content to the computing devices 26, 28, 30. One or more computers 132 communicate via a network 134 and form a computing environment 130 (e.g., a distributed computing environment). Each of the computers 132 in the computing environment 130 can be used to perform at least a portion of the calculation techniques according to any of the disclosed embodiments. The network 134 in the illustrated embodiment is also coupled to one or more client computers 136.

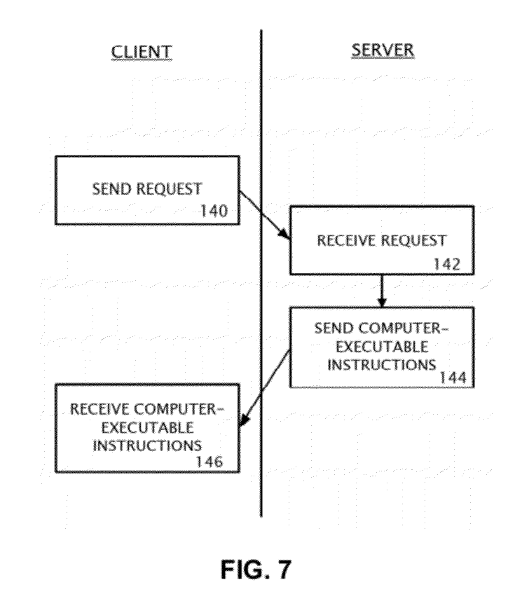

FIG. 7 shows one exemplary manner in which computer-executable instructions for performing any of the disclosed embodiments can be transmitted, accessed, or received using a remote server computer (such as the server computer 120 shown in FIG. 5) or a remote computing environment (such as the computing environment 130 shown in FIG. 6). At process block 140, for example, the client computer sends a request to download computer-executable instructions for performing any of the disclosed methods or techniques (e.g., after registering or logging in to the system). In process block 142, the request is received by the remote server or by respective components of the remote computing environment. In process block 144, the remote server or computing environment transmits computer-executable instructions for performing any of the disclosed methods or techniques. At 146, the computer-executable instructions are received (e.g., stored, buffered, and/or executed) by the client computer.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A method for developing and hosting application software for advertisers, the method comprising:
providing a plurality of templates of social media apps for selection by an advertiser;
receiving one or more selections by the advertiser from the plurality of templates;
creating an app for use within a social network based on the received selections;
hosting the created app on a server and providing the created app with a uniform resource locator (URL); and
providing the advertiser with the URL of the created app so that the advertiser can share the URL with a plurality of users.

2. The method of claim 1, wherein the created app is a Facebook app.

3. The method of claim 2, wherein the Facebook app is able to collect social or demographic data about the users from Facebook.

4. A method for developing and hosting application software for advertisers, the method comprising:
creating apps for use within a social network for a plurality of advertisers based on preferences selected by the advertisers;
hosting and maintaining the created apps on a server and providing each of the created apps with a unique uniform resource locator (URL); and
publishing the created apps by presenting advertisements with one of the URLs linked to the advertisements, the advertisements being presented within the social network,
wherein the created apps are operable within the social network.

5. The method of claim 4, wherein the created app is a Facebook app and the advertisements are advertisements within Facebook.

6. The method of claim 5, wherein the Facebook app is able to collect social or demographic data about the users from Facebook.

7. A computer-readable storage medium storing computer-executable instructions for causing a computer to perform a method, the method comprising:
providing a plurality of templates of social media apps for selection by an advertiser;
receiving one or more selections by the advertiser from the plurality of templates;
creating an app for use within a social network based on the received selections;
hosting the created app on a server and providing the created app with a uniform resource locator (URL); and
providing the advertiser with the URL of the created app so that the advertiser can share the URL with a plurality of users.
